(19) United States
(12) Patent Application Publication
(10) Pub. No.: US 2024/0326022 A1
(43) Pub. Date: Oct. 3, 2024

(54) SINGLE ATOM CATALYST BASED ON CARBON NANOTUBE AND MANUFACTURING METHOD THEREOF

(71) Applicant: KOREA INSTITUTE OF SCIENCE AND TECHNOLOGY, Seoul (KR)

(72) Inventors: Nam Dong KIM, Wanju-gun (KR); Jae Young JUNG, Wanju-gun (KR); Sung Jong YOO, Seoul (KR); Bon-Cheol KU, Wanju-gun (KR); Min Woo KIM, Wanju-gun (KR); Hyeonsu JEONG, Wanju-gun (KR)

(21) Appl. No.: 18/604,220

(22) Filed: Mar. 13, 2024

(30) Foreign Application Priority Data
Mar. 28, 2023 (KR) 10-2023-0040301
Jul. 3, 2023 (KR) 10-2023-0085566

(51) Int. Cl. B01J 23/75; B01J 21/18; B01J 35/30; B01J 35/45; B01J 35/50; B01J 35/61; B01J 37/02; B01J 37/08

(52) U.S. Cl. CPC B01J 23/75; B01J 21/185; B01J 35/393; B01J 35/394; B01J 35/45; B01J 35/505; B01J 35/617; B01J 37/0221; B01J 37/088

(57) ABSTRACT

Provided is a single atom catalyst based on a carbon nanotube according to the present invention including a carbon support; and single atom metals supported on the carbon support, wherein the carbon support has a cone shape with an empty space formed therein and includes at least one carbon support having an open tip of the corn-shaped carbon support.

### CROSS-REFERENCE TO RELATED APPLICATIONS

This application claims priority to and the benefit of Korean Patent Application No. 10-2023-0040301 filed in the Korean Intellectual Property Office on Mar. 28, 2023, and Korean Patent Application No. 10-2023-0085566 filed in the Korean Intellectual Property Office on Jul. 3, 2023, the entire contents of which are incorporated herein by reference.

### BACKGROUND OF THE INVENTION

### (a) Field of the Invention

The present invention relates to a single atom catalyst based on a carbon nanotube with high strength and high specific surface area and a manufacturing method thereof.

### (b) Description of the Related Art

Metal-supported catalysts have been widely used in various industrial fields due to high activity, selectivity, and stability of the catalysts, and research has been conducted to highly disperse metals in small sizes to maximize the use of expensive metals.

In particular, single atom-sized metal catalysts exhibit different catalytic activities due to not only the high dispersion of metals, but also different electrical properties from general metal catalysts. In addition, these catalysts may maximize catalytic activity and have received a lot of attention by showing high chemoselectivity due to extremely limited active sites compared to catalysts with metal clusters with many active sites.

However, single atom-sized metals are very unstable due to properties to aggregate in order to maximize their surface energy. Accordingly, it is possible to synthesize a single atom-sized metal catalyst only by using a catalyst support that may stabilize the metal even at the single atom size due to a strong bond with the metal. Catalyst supports that may stabilize metals even at the single atom sizes through strong bonds with metals are mostly insulators or ceramics. Since these insulators or ceramic supports have excellent mechanical strength, a top-down approach method has been used to introduce metal atoms by adsorbing metal atoms and then introducing strong energy (e.g., ball mill). However, the insulators or ceramic supports have low electrical conductivity and are unstable under electrochemical conditions, thereby making it almost impossible to apply single atom-sized metal catalysts supported on these supports to electrochemical reactions. Therefore, there is a need for a catalyst support that has high electrical conductivity and may stabilize metals even at the single atom sizes.

In order to solve the problems, in Korean Patent Application No. KR10-2018-0136808, the present inventors proposed a manufacturing method of a single atom catalyst supported on a carbon support by treating a mixture of a carbon support precursor and precursors of heterogeneous elements other than carbon in a dry gas phase process to support a single atom type of catalyst containing heterogeneous elements other than carbon on a carbon support. However, there is still a need for a method for achieving high strength and high specific surface area.

### SUMMARY OF THE INVENTION

The present disclosure attempts to provide a single atom catalyst based on a carbon nanotube with high strength and high specific surface area and a manufacturing method thereof.

An exemplary embodiment of the present invention provides a single atom catalyst based on a carbon nanotube including a carbon support; and single atom metals supported on the carbon support; in which the carbon support may have a cone shape with an empty space formed therein.

The carbon nanotube may include at least one carbon support having an open tip of the corn-shaped carbon support.

The specific surface area of the single atom catalyst based on the carbon nanotube may be in the range of 550 m²/g to 900 m²/g.

The FWHM of a peak located at 2θ of 26°±0.5 may be 1.44 or less in XRD analysis of the single atom catalyst based on the carbon nanotube.

The single atom metal may be included in the range of 0.1 wt % to 1.0 wt % based on the total weight of the single atom catalyst based on the carbon nanotube.

The cross-section diameter of the open tip may be 2 nm or less.

The carbon support may include at least one selected from a single-walled nanotube or a multi-walled nanotube.

The plurality of primary particles of the single atom catalyst based on the carbon nanotube may be aggregated to form secondary particles, and the mean particle size D50 of the secondary particles may be 30 nm to 160 nm.

The single atom metal may be supported by nitrogen atoms bound with carbon elements.

Another exemplary embodiment of the present invention provides a manufacturing method of a single atom catalyst based on a carbon nanotube, the manufacturing method including: obtaining a first intermediate by mixing a carbon precursor and a metal precursor and treating the mixture to a dry gas phase process in an inert gas atmosphere; obtaining a second intermediate by heat-treating the obtained first intermediate in an atmosphere where oxygen-containing gas is continuously supplied; and obtaining a single atom catalyst based on a carbon nanotube by heat-treating the obtained second intermediate in an atmosphere where ammonia gas is continuously supplied.

In the obtaining of the second intermediate by heat-treating the obtained first intermediate in an atmosphere in which oxygen-containing gas is continuously supplied, nitrogen gas may be mixed with the ammonia gas and supplied.

In the obtaining of the single atom catalyst based on the carbon nanotube by heat-treating the obtained second intermediate in the atmosphere where ammonia gas is continuously supplied, the heat treating may be performed at a temperature in the range of 550° C. to 850° C.

In the obtaining of the single atom catalyst based on the carbon nanotube by heat-treating the obtained second intermediate in the atmosphere where ammonia gas is continuously supplied, the heat treating may be performed for 30 minutes to 180 minutes.

In the obtaining of the second intermediate by heat-treating the obtained first intermediate in an atmosphere in which oxygen-containing gas is continuously supplied, the heat treating may be performed at a temperature in the range of 300° C. to 400° C.

According to the exemplary embodiment of the present invention, a single atom catalyst based on a carbon nanotube has excellent activity and selectivity of the catalyst by simultaneously securing the characteristics of high strength and high specific surface area.

According to the exemplary embodiment of the present invention, by a manufacturing method of the single atom catalyst based on the carbon nanotube, it is possible to manufacture a single atom catalyst based on a carbon nanotube with both high strength and high specific surface area.

### BRIEF DESCRIPTION OF THE DRAWINGS

FIG. 1 is a schematic diagram of a manufacturing method of a single atom catalyst based on a carbon nanotube according to an exemplary embodiment of the present invention.

FIG. 2 illustrates XDR analysis results of catalysts according to Example 1, and Comparative Examples 1 and 2.

FIG. 3 illustrates an SEM image of a catalyst according to Example 1.

FIG. 4A and FIG. 4B illustrate TEM images of a catalyst according to Example 1.

FIG. 5 is an enlarged diagram of a TEM image of a catalyst according to Example 1.

FIG. 6 illustrates a HAADF-STEM image of a catalyst according to Example 1.

FIG. 7 illustrates EXAFS analysis results of catalysts according to Comparative Examples 1 and 2 and Example 1.

FIG. 8A, FIG. 8B, FIG. 8C and FIG. 8D illustrate LSV measurement results of catalysts according to Comparative Examples 1 and 2 and Example 1.

FIG. 9A and FIG. 9B illustrate LSV result graphs of measuring changes in catalyst activity according to Examples 1 to 5.

### DETAILED DESCRIPTION OF THE EMBODIMENTS

Terms such as first, second, third, etc. are used to describe various parts, components, regions, layers and/or sections, but are not limited thereto. These terms are only used to distinguish any one part, component, region, layer or section from the other part, component, region, layer, or section. Accordingly, a first part, component, region, layer, or section to be described below may be referred to as a second part, component, region, layer, or section without departing from the scope of the present invention.

The technical terms used herein are for the purpose of describing specific exemplary embodiments only and are not intended to be limiting of the present invention. The singular forms used herein include plural forms as well if the phrases do not clearly have the opposite meaning. The “comprising” used in the specification means that a specific feature, region, integer, step, operation, element and/or component is embodied and other specific features, regions, integers, steps, operations, elements, components, and/or groups are not excluded.

When a part is referred to as being “above” or “on” the other part, the part may be directly above or on the other part or may be followed by another part therebetween. In contrast, when a part is referred to as being “directly on” the other part, there is no intervening part therebetween.

Unless defined otherwise, all terms including technical and scientific terms used herein have the same meaning as commonly understood by those skilled in the art to which the present invention pertains. Terms defined in commonly used dictionaries are further interpreted as having meanings consistent with related technical literatures and currently disclosed contents and are not interpreted in ideal or very formal meanings unless defined otherwise.

In addition, unless otherwise specified, % means vol %, and 1 ppm is 0.0001 vol %.

Throughout this specification, the term “combination(s) thereof” included in the expression of the Markush form means one or more mixtures or combinations selected from the group consisting of components described in the expression of the Markush form and means including at least one selected from the group consisting of the components.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

### <Single Atom Catalyst Based on Carbon Nanotube>

A single atom catalyst based on a carbon nanotube according to an exemplary embodiment of the present invention includes a carbon support; and single atom metals supported on the carbon support.

In the present invention, the “single atom catalyst” means that catalyst materials are dispersed and evenly supported on the carbon support in single atom units and is distinguished from a catalyst in which nanoparticles or microparticles formed by aggregating the catalyst materials are supported on the carbon support. Since the catalyst materials are dispersed in single atom units on the carbon support, the catalyst has an advantage of excellent activity and selectivity.

The carbon support may have a cone shape, specifically a cone shape with an empty space formed therein. One tip of the cone-shaped carbon support may be open, and specifically, a relatively narrow tip may be open. In the present invention, a relatively wide tip located opposite to the narrow tip may also be open and is not particularly limited.

The cross-sectional diameter of the open tip may be 0.1 nm to 5 nm, specifically 0.2 nm to 3 nm, and more specifically 0.3 nm to 2 nm.

In the present invention, the cross-sectional diameter of the tip of the cone-shaped carbon support may be measured from the results of TEM analysis. Here, the TEM analysis was imaged at 86,000 magnifications or 400,000 magnifications by Tecnai G2 F20, USA with an accelerating voltage of 200 kV. In order to prepare a TEM specimen, the carbon support powder was mixed with an ethanol solvent and then ultrasonic dispersed to prepare a mixed solution. Then, the mixed solution was dipped into a TEM grid and then dried to prepare the TEM specimen.

In the single atom catalyst based on the carbon nanotube according to an exemplary embodiment of the present invention, the carbon support may include at least one selected from a single-walled nanotube (SWCNT) or a multi-walled nanotube (MWCNT).

The single atom catalyst based on the carbon nanotube according to an exemplary embodiment of the present invention may include one or more carbon supports including the open tip.

In addition, the single atom catalyst based on the carbon nanotube according to an exemplary embodiment of the present invention may be secondary particles formed by aggregating a plurality of primary particles of the single atom catalyst based on the carbon nanotube, and the mean particle size (D50) of the secondary particles may be 10 nm to 300 nm, specifically 20 nm to 200 nm, and more specifically 30 nm to 160 nm.

In the present invention, the mean particle size of the secondary particles may be measured from SEM analysis images, wherein the SEM analysis was taken at a magnification of 200,000 by Nova Nano SEM 450, FEI, USA with an acceleration voltage of 10 kV. An SEM analysis sample was prepared by fixing the carbon support powder in a powder form on an analysis substrate.

The single atom catalyst based on the carbon nanotube according to an exemplary embodiment of the present invention may have a specific surface area in the range of 50 m²/g to 1000 m²/g, specifically 550 m²/g to 900 m²/g, and more specifically 590 m²/g to 860 m²/g.

In XRD analysis of the single atom catalyst based on the carbon nanotube according to an exemplary embodiment of the present invention, the FWHM of a position peak at 2θ of 26°±0.5 may be 1.44 arcsec or less.

The single atom catalyst based on the carbon nanotube may include at least one single atom metal selected from cobalt (Co), iron (Fe), nickel (Ni), rhodium (Rh), and iridium (Ir). In addition, the single atom catalyst based on the carbon nanotube may include at least one non-metal of nitrogen (N), boron (B), sulfur(S), selenium (Se), phosphorus (P), fluorine (F), chlorine (Cl), bromine (Br), and iodine (I). For example, the single atom catalyst based on the carbon nanotube may include at least one non-metal of nitrogen (N), boron (B), sulfur (S), selenium (Se), phosphorus (P), fluorine (F), chlorine (Cl), bromine (Br) and iodine (I); at least one transition metal of cobalt (Co), iron (Fe), nickel (Ni), rhodium (Rh), and iridium (Ir); or a combination thereof. For example, the single atom catalyst may include nitrogen (N), cobalt (Co), or a combination thereof. For example, the single atom catalyst may include both nitrogen (N) and cobalt (Co). For example, the single atom catalyst may include nitrogen (N) or cobalt (Co).

More specifically, the single atom metals may be supported by nitrogen elements bound with carbon elements.

The single atom metals included in the single atom catalyst based on the carbon nanotube may be included in an amount of 0.01 to 10 wt %, specifically 0.05 to 5 wt %, and more specifically 0.1 to 1.0 wt %, based on the total weight of the single atom catalyst based on the carbon nanotube. When the amount of single atom metals supported is within the range, the catalyst may be evenly dispersed in a single atom form on the carbon support, and the catalyst has excellent activity and selectivity.

### <Manufacturing Method of Single Atom Catalyst Based on Carbon Nanotube>

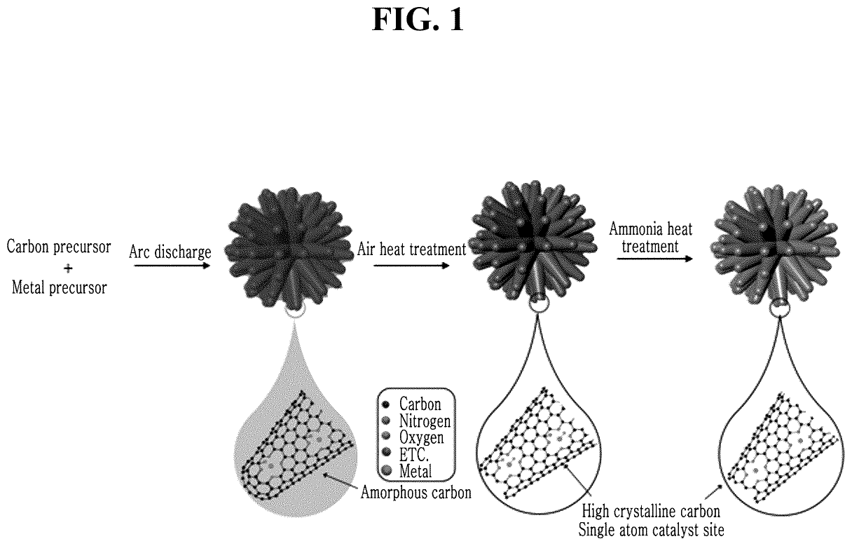

FIG. 1 is a schematic diagram of a manufacturing method of a single atom catalyst based on a carbon nanotube according to an exemplary embodiment of the present invention.

Referring to FIG. 1, a manufacturing method of a single atom catalyst based on a carbon nanotube according to an exemplary embodiment of the present invention may include obtaining a first intermediate by mixing a carbon precursor and a metal precursor and treating the mixture to a dry gas phase process in an inert gas atmosphere; obtaining a second intermediate by heat-treating the obtained first intermediate in an atmosphere where oxygen-containing gas is continuously supplied; and obtaining a single atom catalyst based on a carbon nanotube by heat-treating the obtained second intermediate in an atmosphere where ammonia gas is continuously supplied.

In the obtaining of the first intermediate by mixing the carbon precursor and the metal precursor and treating the mixture to the dry gas phase process in the inert gas atmosphere in the manufacturing method of the single atom catalyst based on the carbon nanotube, the carbon precursor refers to a raw material of the carbon support, and may include, for example, at least one selected from graphite, C₂H₂, CH₄, C₂H₄, C₂H₆ and C₂H₅OH.

The dry vapor phase process may be at least one process selected from thermal chemical vapor deposition, plasma synthesis, high temperature plasma, plasma enhanced chemical vapor deposition, laser evaporation, laser ablation, and vapor phase growth.

The dry gas phase process may specifically be an arc discharge process. The arc discharge may be performed at a voltage of 10 to 50 V, specifically at a voltage of 20 to 40 V, and more specifically at a voltage of 25 to 35 V. Meanwhile, the arc discharge may be performed under a current of 50 to 300 A, specifically under a current of 100 to 200 A, and more specifically under a current of 150 to 200 A. By adjusting the voltage and current of the arc discharge within the above range, there is an advantage in that single atom catalysts may be uniformly dispersed and supported on a carbon support to produce a catalyst.

The dry gas phase process according to an exemplary embodiment of the present invention may be performed under a gaseous atmosphere of a non-metal-containing precursor. Specifically, the arc discharge may be performed under a gaseous atmosphere of a non-metal-containing precursor. For example, when a reaction chamber is filled with nitrogen-containing gas and then the carbon precursor powder is subjected to arc discharge, nitrogen (N) may be evenly dispersed at the single atom level on the produced carbon precursor. Specifically, when the reaction chamber is filled with nitrogen-containing gas and then the mixed powder of the carbon precursor and the metal precursor is subjected to arc discharge, nitrogen (N) and the metals may be evenly dispersed at the single atom level on the produced carbon support.

The obtaining of the second intermediate by heat-treating the obtained first intermediate in an atmosphere in which oxygen-containing gas is continuously supplied may be a step of performing heat treatment while the oxygen-containing gas is continuously supplied. The obtained intermediate is charged into the chamber and then heat treated by slowly increasing the temperature while the oxygen-containing gas is continuously supplied. At this time, the supplied oxygen-containing gas may pass through the first intermediate located in the chamber and then be discharged to the outside through a gas outlet of the chamber, and the inside of the chamber may be at normal pressure. The oxygen-containing gas may specifically be air, and may be supplied at a supply rate of 150 cc/min to 250 cc/min. The chamber temperature increase rate may be 3° C./min to 6° C./min. The chamber may be heated to a temperature in the range of 200° C. to 500° C., specifically to a temperature in the range of 250° C. to 450° C., and more specifically to a temperature in the range of 300° C. to 400° C., and then maintained at the temperature for a predetermined period of time, specifically for 30 to 180 minutes. By heat treating the first intermediate under the conditions, one tip of the cone-shaped carbon support may be open, and specifically, a relatively narrow tip may be open.

The obtaining of the single atom catalyst based on the carbon nanotube by heat-treating the obtained second intermediate in the atmosphere where ammonia gas is continuously supplied may be a step of performing heat treatment while ammonia gas is continuously supplied. After completing the step of preparing the first intermediate, the temperature is gradually increased while continuously supplying ammonia gas instead of the oxygen-containing gas, to be increased to be in the range of 550° C. to 850° C., specifically, in the range of 600° C. to 800° C. At this time, the temperature increase rate may be 3° C./min to 6° C./min. Meanwhile, the ammonia gas supply rate may be in the range of 350 cc/min to 450 cc/min.

Meanwhile, nitrogen gas may be additionally mixed with the ammonia gas and supplied to the chamber. At this time, the nitrogen gas may be mixed with ammonia gas at a ratio of 0 to 80 vol %.

By heat treating the second intermediate under the above conditions, there is an advantage in that it is possible to further improve the specific surface area and strength of the single atom catalyst based on the carbon nanotube.

Hereinafter, preferred Examples and Comparative Examples of the present invention will be described. However, the following Examples are only a preferred example of the present invention and the present invention is not limited to the following Examples.

### Comparative Example 1

0.6 g of CoCl₂ and 0.6 g of Vulcan XC-72 were mixed in 150 mL acetone, and then evaporated and dried in a rotary evaporator at 140 rpm in a 45° C. water bath. Next, the metal mixture powder was mixed with graphite powder and charged into the chamber. For arc discharge, a cathode was introduced into the reaction chamber, charged with a nitrogen atmosphere, and applied with a 30V voltage and 150 A current for 5 minutes at a pressure of 300 torr to generate an intense arc. After completion of the reaction, the catalyst was obtained by leaving the mixture in a vacuum for 30 minutes and cooling to room temperature.

### Comparative Example 2

The product material obtained in Comparative Example 1 was charged into the chamber, and then maintained for 30 minutes by forming an air atmosphere inside the chamber and then increasing the temperature to 300° C. to 400° C. at the temperature increase rate of 5° C./min while supplying the air into the chamber at a supply rate of 200 cc/min. Next, the catalyst was obtained by cooling to room temperature.

### Example 1

The product material obtained in Comparative Example 2 was charged into the chamber, and then maintained for 1 hour by forming an ammonia gas atmosphere inside the chamber and then increasing the temperature to 700° C. at the temperature increase rate of 5° C./min while supplying nitrogen gas at a supply rate of 200 cc/min and ammonia gas at a supply rate of 200 cc/min into the chamber. Next, the catalyst was obtained by cooling to room temperature.

### Examples 2 and 3

A catalyst was prepared in the same manner as in Example 1, except that the temperature was increased to 600° C. (Example 2) and 800° C. (Example 3) at a temperature increase rate of 5° C./min.

### Examples 4 and 5

A catalyst was prepared in the same manner as in Example 1, except that the temperature was increased to 700° C. at a temperature increase rate of 5° C./min and maintained for 60 and 120 minutes.

### Evaluation Example 1: X-Ray Diffraction (XRD) Analysis

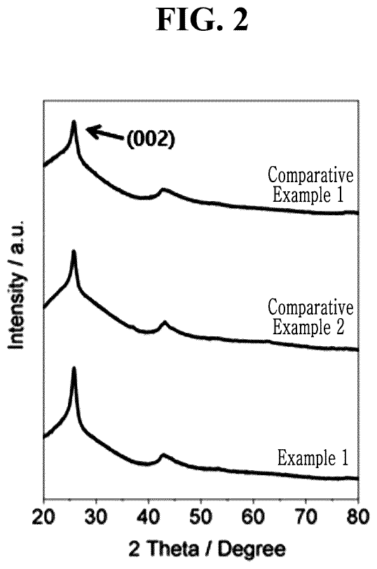

X-ray diffraction (XRD) analysis was performed on the catalysts prepared according to Comparative Examples 1 and 2 and Example 1, and the analysis results were shown in FIG. 2.

Referring to FIG. 2, it was confirmed that in the case of Example 1, a peak shown near 25° had a relatively sharp shape compared to those of Comparative Examples 1 and 2. In addition, the FWHM of the peak was calculated and shown in Table 1 below.

Referring to FIG. 2 and Table 1, it can be seen that the crystallinity of the catalyst according to Example 1 is relatively excellent.

The XRD analysis and the FWHM calculation method used conventional methods, and detailed descriptions will be omitted in this specification.

TABLE 1

| | Comparative | Comparative | |
|---|---|---|---|
| | Example 1 | Example 2 | Example 1 |
| BET specific surface | 84 | 366 | 696 |
| area (m² g⁻¹) | | | |
| XRD FWHM | 2.08 | 1.92 | 1.44 |
| D 002 distance (Å) | 3.4 | 3.4 | 3.4 |
| Lc size (nm) | 4.1 | 4.44 | 5.92 |

### Evaluation Example 2: BET Analysis

BET analysis was performed on the catalysts prepared according to Comparative Examples 1 and 2 and Example 1, and the analysis results were shown in Table 1.

Referring to Table 1, it was shown that the BET area of the catalyst prepared according to Example 1 was higher than those of Comparative Examples 1 and 2.

In the present invention, the “specific surface area” was measured using a Brunauer-Emmett-Teller Analysis method according to a nitrogen adsorption method, and a method for measuring a specific surface area was adopted by adsorbing or desorbing nitrogen gas on the surface of a solid sample using the BET (Brunauer Emmett Teller) Formula to measure an adsorption amount for each partial pressure.

### Evaluation Example 3: SEM and TEM Analysis

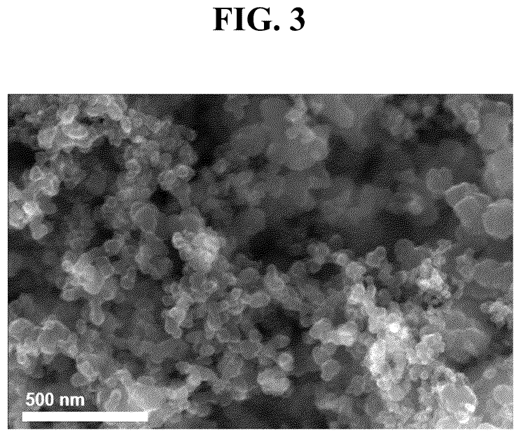

Scanning electron microscopy (SEM) analysis was performed on the catalyst prepared according to Example 1, and the observed SEM image at 200,000 magnification was shown in FIG. 3.

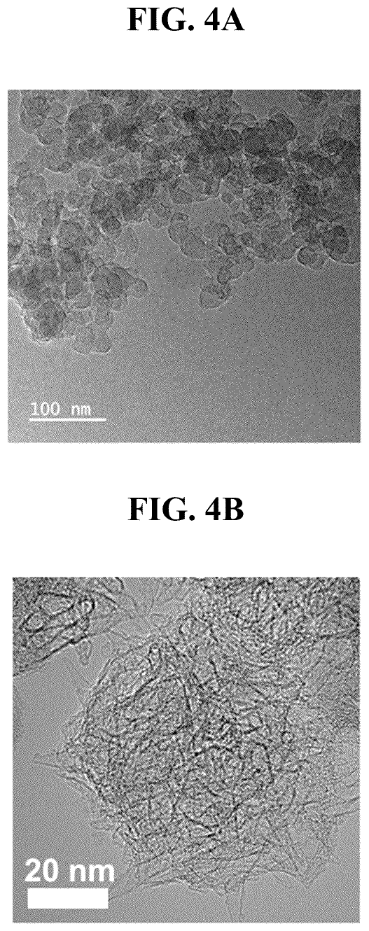

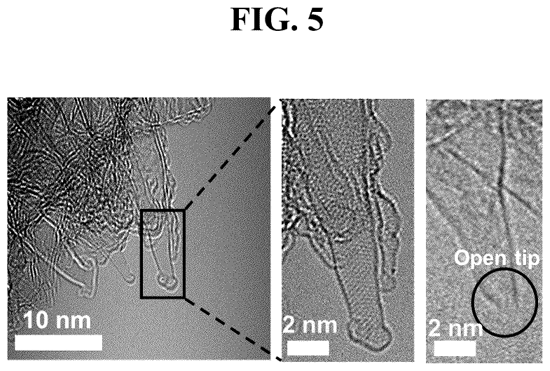

Transmission electron microscopy (TEM) analysis was performed on the catalyst prepared according to Example 1, and the observed TEM images were shown in FIG. 4A and FIG. 4B, and partially enlarged in FIG. 5.

FIG. 4A shows a TEM image at 86,000 magnification, and FIG. 4B shows a TEM image at 400,000 magnification.

Referring to FIGS. 3 to 5, it can be seen that the catalyst prepared according to Example 1 has a substantially spherical particle shape, and that the particles are secondary particles formed by aggregating a plurality of primary particles.

Meanwhile, referring to FIG. 5, it can be seen that the catalyst prepared according to Example 1 contains cone-shaped primary particles, and the tips of some cone-shaped primary particles have an open shape. Meanwhile, it can be seen that the diameter of the relatively narrow tip of the cone-shaped primary particle is 5 nm or less, specifically 3 nm or less, and more specifically 2 nm or less.

It can be seen that the specific surface area of the catalyst prepared according to the present invention increases by including cone-shaped particles with open tips as described above.

### Evaluation Example 4: HAADF-STEM Analysis

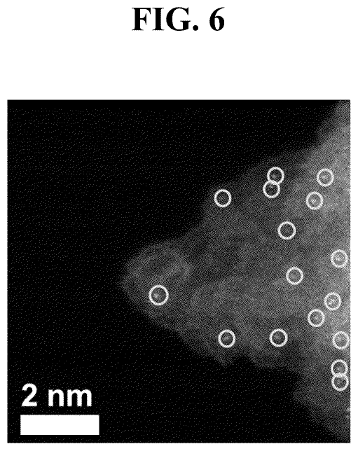

High-angle annular dark-field scanning transmission electron microscopy (HAADF-STEM) analysis was performed on the catalyst prepared according to Example 1, and the analysis results were shown in FIG. 6.

Referring to FIG. 6, it can be seen that single atom Co metal is dispersed without aggregation in the catalyst prepared according to Example 1.

### Evaluation Example 5: EXAFS Analysis

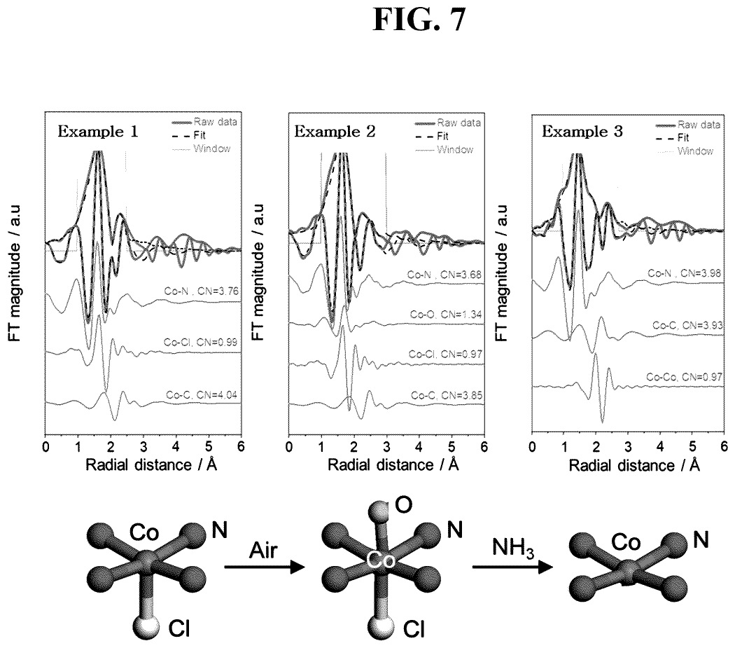

EXAFS analysis was performed on the catalysts prepared according to Comparative Examples 1 to 2 and Example 1, and the analysis results were shown in FIG. 7.

Referring to FIG. 7, it can be seen that a Co—N bond (1.911 Å) length of the catalyst prepared according to Example 1 is relatively shorter than those of Comparative Examples 1 and 2, so that Co and N are well bound.

### Evaluation Example 6: Evaluation of Catalyst Activity

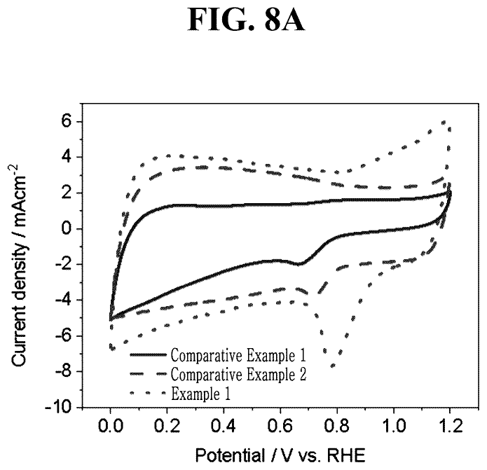

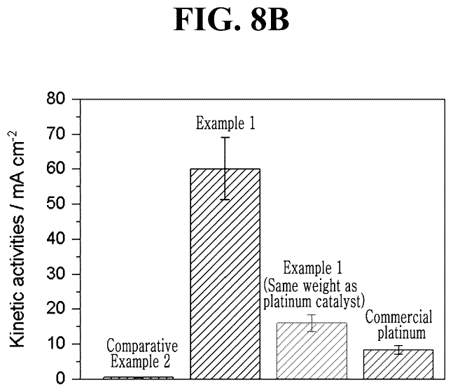

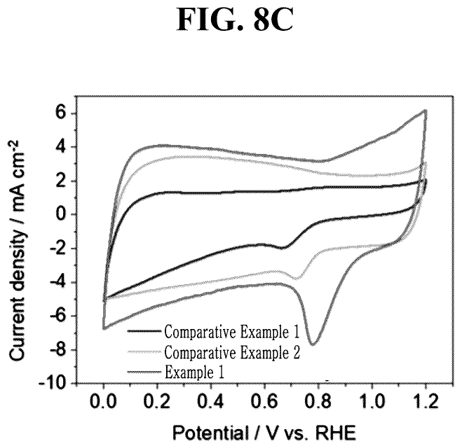

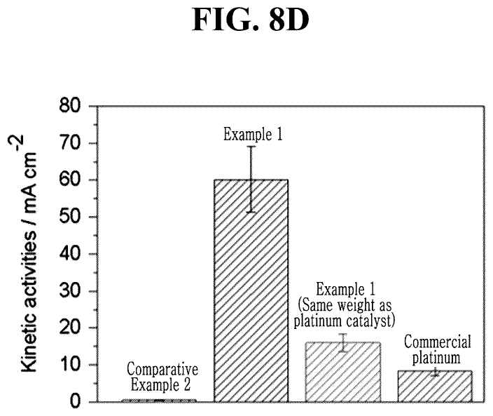

Linear sweep voltammetry (LSV) measurement was performed on the catalysts prepared according to Comparative Examples 1 to 2 and Example 1, and the results were shown in FIG. 8A and FIG. 8B.

Referring to FIG. 8A, it was shown that a reduction peak of the catalyst prepared according to Example 1 of the present invention increased compared to those of Comparative Examples 1 and 2. Referring to FIG. 8B, it can be seen that the catalyst according to Example 1 has higher performance than a commercial Pt catalyst when subjected to an oxygen reduction reaction.

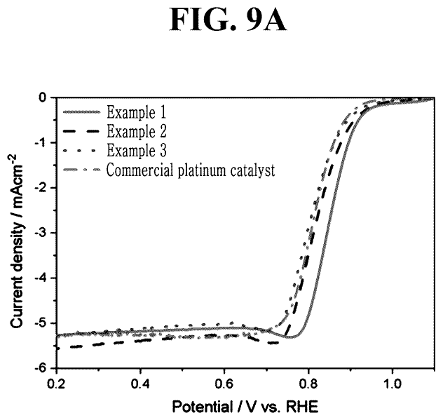

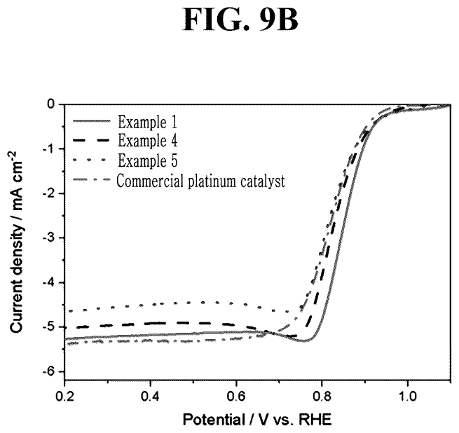

The LSV measurement results of the catalysts prepared according to Examples 1 to 3 were shown in FIG. 9A, and the LSV measurement results of the catalysts prepared according to Examples 1, 3, and 4 were shown in FIG. 9B.

Referring to FIG. 9A, it can be seen that the catalysts prepared according to Examples 1 to 3 exhibit similar activity to commercial Pt catalysts.

Referring to FIG. 9B, it was shown that in Example 5 where the heat treatment time was 180 minutes, the catalyst activity was somewhat reduced, which can be described by the collapse of the carbon structure.

While this invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

Therefore, the substantial scope of the present invention will be defined by the appended claims and equivalents thereof.

What is claimed is:

1. A single atom catalyst based on a carbon nanotube comprising:
a carbon support; and
single atom metals supported on the carbon support;
wherein the carbon support has a cone shape with an empty space formed therein, and
includes at least one carbon support having an open tip of the corn-shaped carbon support.

2. The single atom catalyst based on the carbon nanotube of claim 1, wherein:
the specific surface area of the single atom catalyst based on the carbon nanotube is in the range of 550 m²/g to 900 m²/g.

3. The single atom catalyst based on the carbon nanotube of claim 1, wherein:
the FWHM of a peak located at 2θ of 26°±0.5 is 1.44 or less in XRD analysis of the single atom catalyst based on the carbon nanotube.

4. The single atom catalyst based on the carbon nanotube of claim 1, wherein:
the single atom metal is included in the range of 0.1 wt % to 1.0 wt % based on the total weight of the single atom catalyst based on the carbon nanotube.

5. The single atom catalyst based on the carbon nanotube of claim 1, wherein:
the cross-section diameter of the open tip is 2 nm or less.

6. The single atom catalyst based on the carbon nanotube of claim 1, wherein:
the carbon support includes at least one selected from a single-walled nanotube or a multi-walled nanotube.

7. The single atom catalyst based on the carbon nanotube of claim 1, wherein:
the plurality of primary particles of the single atom catalyst based on the carbon nanotube are aggregated to form secondary particles.

8. The single atom catalyst based on the carbon nanotube of claim 7, wherein:
the mean particle size D50 of the secondary particles is 30 nm to 160 nm.

9. The single atom catalyst based on the carbon nanotube of claim 1, wherein:
the single atom metal is supported by nitrogen atoms bound with carbon elements.

10. A manufacturing method of a single atom catalyst based on a carbon nanotube, the manufacturing method comprising:
obtaining a first intermediate by mixing a carbon precursor and a metal precursor and treating the mixture to a dry gas phase process in an inert gas atmosphere;
obtaining a second intermediate by heat-treating the obtained first intermediate in an atmosphere where oxygen-containing gas is continuously supplied; and
obtaining a single atom catalyst based on a carbon nanotube by heat-treating the obtained second intermediate in an atmosphere where ammonia gas is continuously supplied.

11. The manufacturing method of claim 10, wherein:
in the obtaining of the second intermediate by heat-treating the obtained first intermediate in an atmosphere in which oxygen-containing gas is continuously supplied,
nitrogen gas is mixed with the ammonia gas and supplied.

12. The manufacturing method of claim 10, wherein:
in the obtaining of the single atom catalyst based on the carbon nanotube by heat-treating the obtained second intermediate in the atmosphere where ammonia gas is continuously supplied,
the heat treating is performed at a temperature in the range of 550° C. to 850° C.

13. The manufacturing method of claim 10, wherein:
in the obtaining of the single atom catalyst based on the carbon nanotube by heat-treating the obtained second intermediate in the atmosphere where ammonia gas is continuously supplied,
the heat treating is performed for 30 minutes to 180 minutes.

14. The manufacturing method of claim 10, wherein:
in the obtaining of the second intermediate by heat-treating the obtained first intermediate in an atmosphere in which oxygen-containing gas is continuously supplied,
the heat treating is performed at a temperature in the range of 300° C. to 400° C.
